(19) United States
(12) Patent Application Publication
(10) Pub. No.: US 2025/0103976 A1
(43) Pub. Date: Mar. 27, 2025

(54) SYSTEMS AND METHODS FOR OPTIMIZING LABOR RESOURCES

(71) Applicant: Walmart Apollo, LLC, Bentonville, AR (US)

(72) Inventors: Kartheek Ponnuru, Bengaluru (IN); Jingrui Li, Norman, OK (US); Prachi A. Patki, Bentonville, AR (US); Sophia Burathoki, Bentonville, AR (US); Harshavardhan R. Nannur, Aubrey, TX (US); Ajay Sharma, Bangalore (IN); Ashish Raj, Bengaluru (IN); Mohith Varma, Bengaluru (IN)

(21) Appl. No.: 18/891,593

(22) Filed: Sep. 20, 2024

Related U.S. Application Data
(60) Provisional application No. 63/540,011, filed on Sep. 22, 2023.

(51) Int. Cl. G06Q 10/0631

(52) U.S. Cl. CPC G06Q 10/063116; G06Q 10/06315

(57) ABSTRACT

A system for optimizing labor resources at a facility. The system includes a memory configured to store a first optimization model and a second optimization model. Where the first optimization model, when executed by a control circuit, determines optimal shift patterns for full-time employee schedules and fixed part-time employee schedules over a period of time. Where the second optimization model, when executed by the control circuit, determines headcounts and variable part-time shifts. The system further includes an electronic device configured to execute an application stored in a local memory of the electronic device, the application when executed causes the control circuit to output one or more staffing recommendation levels displayable on the electronic device.

### TECHNICAL FIELD

Various examples of the disclosure relate generally to optimizing labor resources, and more specifically to optimizing labor resources and scheduling for an employer.

### BACKGROUND

For many employers, a crucial business consideration is the efficient planning of labor resources. There are various controls that the employer must consider in order to efficiently curate a labor schedule, such as, for example, optimal shift patterns; headcount numbers for full-time, part-time, and flex-time, employees; variable facility demands based on surge events such as holidays or location-specific events; and various others. Employers are tasked with performing a complex balancing act when weighing these different factors to efficiently meet facility demands.

### SUMMARY

The disclosed examples are described in detail below with reference to the accompanying drawing figures listed below. The following summary is provided to illustrate some examples disclosed herein.

Example solutions include systems and associated methods for improving accuracy in forecasting for resource demands and usage. One such method comprises calculating, by a control circuit communicatively coupled to a memory and one or more databases, an average forecasted demand for each day of a week based on resource data, wherein the resource data is stored in the one or more databases and used in determining forecasted demand, and wherein a first optimization model and a second optimization model are stored in the memory. The method further comprises generating, by the control circuit, a one-week demand estimate based on the calculated average forecasted demand. The method further comprises executing, by the control circuit, the first optimization model using the one-week demand estimate to output optimal shift patterns for full-time employee schedules and fixed part-time employee schedules over a period of time; and executing, by the control circuit, the second optimization model using the optimal shift patterns for the full-time employee schedules and the fixed part-time employee schedules to output headcounts and variable part-time shifts. The method further comprises executing an application stored in a local memory of an electronic device, the application when executed causes the control circuit to output one or more staffing recommendation levels displayable on the electronic device.

### BRIEF DESCRIPTION OF THE DRAWINGS

FIG. 1 illustrates a simplified block diagram of an exemplary system for optimizing labor resources at a facility, according to various examples of this disclosure.

FIG. 2 illustrates a flow diagram of an exemplary process of optimizing labor resources at a facility, according to various examples of this disclosure.

FIG. 3 illustrates a simplified block diagram of components of an exemplary system 300 for optimizing labor resources at a facility, according to various examples of this disclosure.

FIG. 4 illustrates a flow diagram of an exemplary process of optimizing labor resources at a facility, according to various examples of this disclosure.

FIG. 5 illustrates exemplary scenarios for optimizing labor resources at a facility, according to various examples of this disclosure.

FIGS. 6-8 are tables illustrating the results of optimization models, according to various examples of this disclosure.

FIGS. 9 and 10 are graphs illustrating the accuracy of the optimization model, according to various examples of this disclosure.

FIGS. 11-13 illustrate examples of user interfaces utilized in schedule generation, according to various examples of this disclosure.

FIG. 14 is a graph illustrating the accuracy of the optimization model, according to various examples of this disclosure.

FIG. 15 illustrates an exemplary system for implementing any of the process and methods of this disclosure.

### DETAILED DESCRIPTION

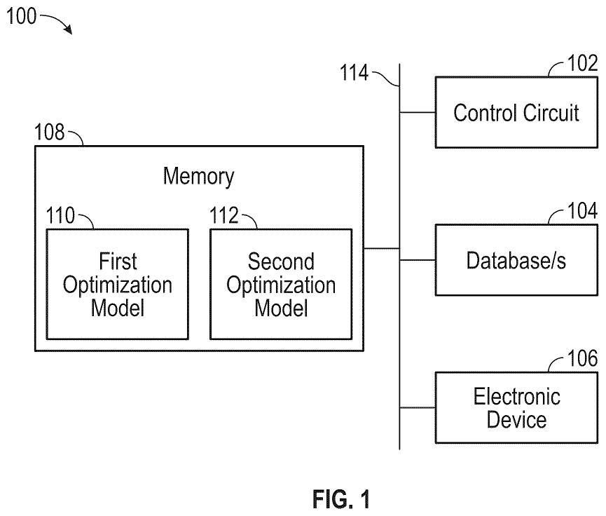

Generally speaking, pursuant to various embodiments, systems, apparatuses and methods are provided herein useful for optimizing labor resources at a facility. In some embodiments, a system 100 for optimizing labor resources at a facility includes a memory 108 storing a first optimization model 110 and a second optimization model 112. In some embodiments, the first optimization model 110 when executed may determine optimal shift patterns for full-time employee schedules and fixed part-time employee schedules over a period of time. In some embodiments, the second optimization model 112 when executed may determine headcounts and variable part-time shifts. Alternatively and/or in addition, the system 100 may include one or more databases 104 storing resource data used in determining forecasted demand. Alternatively and/or in addition, the system 100 may include a control circuit 102 communicatively coupled to the memory 108 and the one or more databases 104. In some embodiments, the control circuit 102 may calculate an average forecasted demand for each day of a week based on the resource data. Alternatively and/or in addition, the control circuit 102 may generate a one-week demand estimate based on the calculated average forecasted demand. Alternatively and/or in addition, the control circuit 102 may execute the first optimization model 110 using the one-week demand estimate to output the optimal shift patterns for the full-time employee schedules and the fixed part-time employee schedules. Alternatively and/or in addition, the control circuit 102 may execute the second optimization model 112 using the optimal shift patterns for the full-time employee schedules and the fixed part-time employee schedules to output the headcounts and the variable part-time shifts. Alternatively and/or in addition, the system 100 may include an electronic device 106 executing an application stored in a local memory of the electronic device 106. In some embodiments, the application when executed may cause the control circuit 102 to output one or more staffing recommendation levels displayable on the electronic device 106. FIG. 1 illustrates a simplified block diagram of an exemplary system for optimizing labor resources at a facility in accordance with some embodiments. For example, the exemplary system includes the system 100 described above. In some embodiments, the memory 108, the control circuit 102, the one or more databases 104, and the electronic device 106 may communicate via a communication network 114. For example, the communication network 114 may include an Internet, a wireless and/or wired network, a Bluetooth network, a local area network, a wide area network, and/or any combination of communication architecture or topology capable of providing a means for electronic components to couple or receive and/or transmit signal or data to one another.

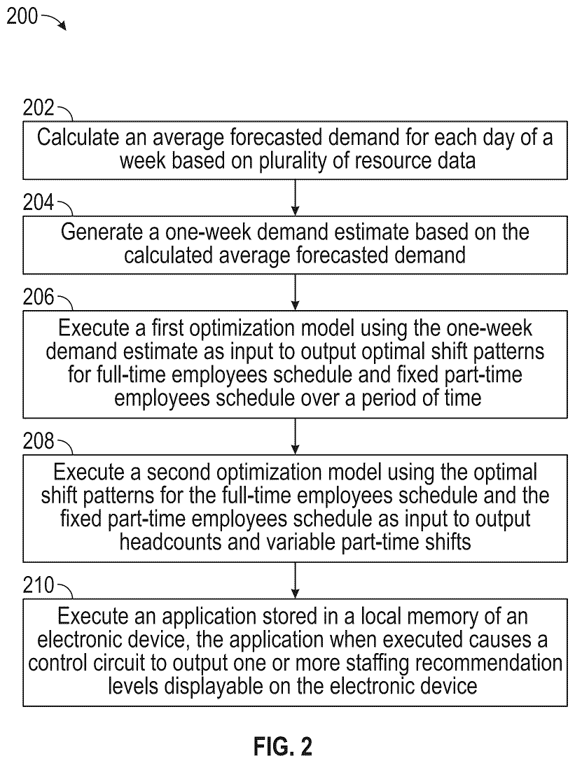

In some embodiments, a method 200 for optimizing labor resources at a facility includes, at step 202, calculating, by a control circuit 102 communicatively coupled to a memory 108 and one or more databases 104, an average forecasted demand for each day of a week based on resource data. In some embodiments, the resource data may be stored in the one or more databases 104 and used in determining forecasted demand. In some embodiments, a first optimization model 110 and a second optimization model 112 are stored in the memory 108. Alternatively and/or in addition, the method 200 may, at step 204, generate, by the control circuit 102, a one-week demand estimate based on the calculated average forecasted demand. Alternatively and/or in addition, the method 200 may, at step 206, execute, by the control circuit 102, the first optimization model 110 using the one-week demand estimate to output optimal shift patterns for full-time employee schedules and fixed part-time employee schedules over a period of time. Alternatively and/or in addition, the method 200 may, at step 208, execute, by the control circuit 102, the second optimization model 112 using the optimal shift patterns for the full-time employee schedules and the fixed part-time employee schedules to output headcounts and variable part-time shifts. Alternatively and/or in addition, the method 200 may, at step 210, execute an application stored in a local memory of an electronic device 106. In some embodiments, the application when executed may cause the control circuit 102 to output one or more staffing recommendation levels displayable on the electronic device 106. FIG. 2 shows a flow diagram of an exemplary process of optimizing labor resources at a facility in accordance with some embodiments. For example, the exemplary method includes the method 200 described above.

In some embodiments, the systems and/or methods use a mixed integer linear programming (MILP) model. The MILP model may employ a multi-layered approach that breaks down a planning horizon into multiple layers; thereby, allowing for more effective optimization of shift patterns and headcounts for full-time and/or part-time shifts. This approach, combined with the incorporation of one or more three shift types: full-time (FT), fixed part-time (FPT), and/or variable part-time (VPT), may enable increased flexibility and adaptability to demand fluctuations. Additionally, in some embodiments, the MILP model may emphasize maintaining consistency in full-time and/or fixed part-time shift patterns throughout the planning horizon; thereby, fostering improved employee satisfaction and reduced turnover. In some embodiments, the first optimization model 110 and the second optimization model 112 may be MILP model based algorithms.

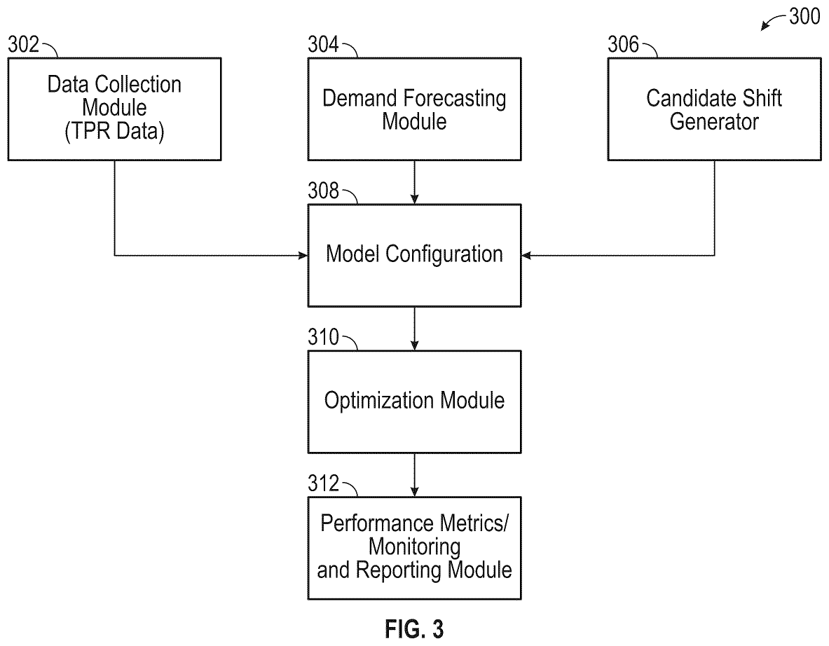

In an illustrative non-limiting example, the model (e.g., MILP model and/or other models) may include a decomposed optimization process consisting of two stages (e.g., a first optimization model 110, and a second optimization model 112). For example, the first stage (e.g., the first optimization model 110) may generate an optimal set of shift patterns for full-time and/or fixed part-time shifts. In some embodiments, the first optimization model 110 may include a set of valid full-time shifts, a set of valid fixed part-time shifts, and/or a set of days within a week. In another example, the second stage (e.g., the second optimization model 112) may optimize variable part-time shift patterns and/or headcounts for all three shift types. In some embodiments, the second optimization model 112 may include the set of valid full-time shifts, the set of valid fixed part-time shifts, and/or the set of day within a week. In some embodiments, the decomposition may allow the model to handle complex business rules and constraints more efficiently than standard models that address the entire problem in a single optimization step. Furthermore, the model may create a pool of validated candidate shift patterns for full-time, fixed part-time, and/or variable part-time shifts based on various business rules; thereby ensuring practical and feasible solutions. In some embodiments, the model may encompass comprehensive components as shown in FIG. 3. As will be discussed in greater detail according to various examples herein, the first optimization model 110 and the second optimization model 112 allow for a resource schedule to be built in two separate stages. In the first stage, the first optimization model 110 determines an optimal shift pattern. Next, in the second stage, the optimal shift pattern determined by the first optimization model 110 is used by the second optimization model 112 to determine appropriate headcounts for various employee-types to meet the demands of the employer and according to the determined shift patterns provided by the first optimization model 110. Building the resource schedule using these two separate stages ensures all employer constraints and considerations are efficiently and appropriately considered during the schedule creation.

FIG. 3 illustrates a simplified block diagram of components of an exemplary system 300 for optimizing labor resources at a facility in accordance with some embodiments. In some embodiments, the system 300 may correspond to the system 100 of FIG. 1. For example, the model may include a data collection module 302, a demand forecasting module 304, a candidate shift generator module 306, a model configuration 308, optimization engine 310, and/or a performance monitoring and reporting module 312. In some embodiments, these components may form an all-encompassing workforce planning solution that enhances the model's effectiveness and adaptability, ultimately offering a more effective and adaptable labor planning strategy for a facility. For example, the data collection module (TPR Data) 302 may include productivity data (e.g., Units per hour) and/or absenteeism information (e.g., average rate of time off (% of vacation to total working time)). In another example, the demand forecasting module 304 may correspond to the expected demand on daily basis for the facility for the entire planning horizon. In another example, the candidate shift generator module 306 may generate the larger pool of valid shifts that are in compliance with human resource (HR) rules. In some embodiments, these shifts may serve as inputs to the first optimization model 110 and the second optimization model 112. In some embodiments, the optimization engine 310 may include the first optimization model 110 and the second optimization model 112. In some embodiments, the performance monitoring and reporting module 312 may include dashboards showing model results and analysis.

In some embodiments, the model configuration 308 may include:
Threshold of Part time man hours w.r.t Full time (4),
Variable PT-to-Total PT ratio (%): Threshold of variable workforce w.r.t fixed workforce. (5),
Daily demand tail (α)−Min % of Daily demand to be met,
Weekly demand tail (β)−Min % of Weekly demand to be met (5), and/or
HC Variability-Weekly variation in overall head count.

In some embodiments, a facility may include a fulfillment center, a retail store, an online store, and/or a distribution center, to name a few.

In an illustrative non-limiting example, the model may include one or more three types of shifts: full-time (FT), fixed part-time (FPT) and/or variable part-time (VPT). For example, full time shifts in the model may be those facility associates that work for most of the typical workweek. In another example, the fixed part-time shifts in the model may be those facility associates that have reduced working hours, with shift hours aligned with the full-time shifts. In some embodiment, when planning labor needs/requirements over a mid-to-long-term timeframe, the model may consider the consistency of shift patterns. For example, both types of shift patterns (FT and FPT) may remain fixed throughout the planning horizon.

The first optimization model 110 and the second optimization model 112 work for any planning horizon. In some embodiments, a predefined value of the planning horizon may be input to one or more of the first optimization model 110 and the second optimization model 112. In some embodiments, one or more users may determine the predefined value in any length of planning horizon. In such embodiments, the one or more of the first optimization model 110 and the second optimization model 112 may generate the fixed shifts dynamically based on the input (e.g., a predefined value of the planning horizon). In an illustrative non-limiting example, if the predefined value of the planning horizon may correspond to 52 weeks, the first optimization model 110 may be generated for a period of 52 weeks.

Alternatively or in addition, variable part-time shifts in the model may be those facility associates having more flexibility in terms of working hours, and their selected shift patterns can vary from week to week. Alternatively or in addition, validation of candidate shift patterns for full-time, fixed part-time and/or variable part-time may be generated or performed by the control circuit 102 according to various business rules and/or saved into a pool (e.g., one or more databases 104) for later usage. In some embodiments, the business rules may include the number of hours for each shift may not exceed 14 hours, the number of hours of part time shifts may not exceed 8 hours, and/or a weekly shift may have at least 2 vacation days, to name a few.

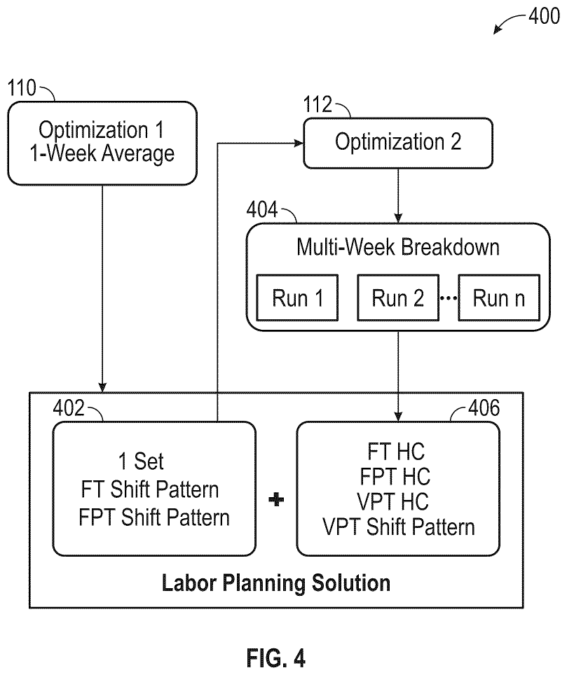

FIG. 4 shows a flow diagram of an exemplary process 400 of optimizing labor resources at a facility in accordance with some embodiments. In some embodiments, the first optimization model 110 generates an optimal set of shift patterns for full-time and fixed part-time at step 402. The optimal set of shift patterns may then be input to the second optimization model 112 in order to generate optimal variable part-time shift patterns at step 404. The second optimization model 112 may, at step 406, decide on the headcounts to be hired for all three shift patterns based on the generated optimal variable part-time shift patterns.

### First Optimization Model 110—Determine Optimal Shift Patterns

In some embodiments, the first optimization model 110 calculates the average forecasted demand for each day of the week to generate a one-week demand estimate. Using this information, the first optimization model 110 may determine the optimal shift patterns for full-time and/or fixed part-time schedules over the planning horizon. For example, the planning horizon may include any number of weeks from 4 weeks to 8 weeks period and/or any number of weeks in accordance to or suitable for the labor resource required by the facility. The first optimization model 110 may include the following sets: [symbol] is set of valid full-time shifts; [symbol] is set of valid fixed part-time shifts; and [symbol] is set of days within a week for the entire planning horizon.

In some embodiments, the first optimization model 110 may define a first set of parameters, first decision variables, and/or first constraints. For example, the first optimization model 110 may define a set of parameters: aᵢⱼ is the number of hours worked on day i for full-time shift j, bᵢₖ is the number of hours worked on day i for fixed part-time shift k; rᵢ is the manhour demand on day i in the pseudo week; α is the daily tail factor; β is the weekly tail factor; B1 is the number of full-time shifts to be chosen; and B2 is the number of part-time shifts to be chosen.

In some embodiments, the ratio between total part-time shift hours to total full-time shift hours may be controlled within a reasonable range: R1 is the upper bound and R2 is the lower bound. M is defined as a big number. Shift validation indicator δⱼ and δₖ may be defined to filter out the demand at zero level, and to prevent selecting shifts with positive hours at the same day. In some embodiments, the decision variables are defined as follows: uⱼ is a binary indicator of full-time shift selection, vₖ is binary indicator of part-time shift selection, xⱼ is the headcount for full-time shift j. yₖ is the headcount for part-time shift k.

In an illustrative non-limiting example, the objective function may be to minimize the total manhour used during the week, in another word, minimizing the labor planning cost.

$$min {\sum }_{i ∈ 𝒟} ( {\sum }_{j ∈ 𝒥} {a}_{ij} {x}_{j} + {\sum }_{k ∈ 𝒦} {b}_{ik} {y}_{k} ) \qquad ( 1 )$$

In some embodiments, the first optimization model 110 may be subjected to the following constraints. First constraint, the daily manhour throughput must cover the daily demand with tail factor adjustment.

$${\sum }_{j ∈ 𝒥} {a}_{ij} {x}_{j} + {\sum }_{k ∈ 𝒦} {b}_{ik} {y}_{k} \geq α {r}_{i} , ∀ i ∈ 𝒟 \qquad ( 2 )$$

The daily tail factor (a) defines the percentage of the daily demand to be covered with α≤1. α=1 makes the model covers 100% of the demand. On the other hand, α<1 allows the demand re-distribution among different days within a week up to percentage of (1−α).

Second constraint, the same concept applies to the weekly manhour throughput. As such, to cover the weekly demand with tail factor adjustment.

$${\sum }_{i ∈ 𝒟} ( {\sum }_{j ∈ 𝒥} {a}_{ij} {x}_{j} + {\sum }_{k ∈ 𝒦} {b}_{ik} {y}_{k} ) \geq β {\sum }_{i ∈ 𝒟} {r}_{i} \qquad ( 3 )$$

The weekly tail factor (β) may be set to 1 in this MILP model, makes the weekly manhour throughput covers 100% of the weekly demand.

Third constraint, daily fixed part-time/full-time manhour ratio may be controlled within a reasonable range.

$${\sum }_{k ∈ 𝒦} {b}_{ik} {y}_{k} \leq R 1 * {\sum }_{j ∈ J} {a}_{ij} {x}_{j} , ∀ i ∈ 𝒟 \qquad ( 4 a )$$

$${\sum }_{k ∈ 𝒦} {b}_{ik} {y}_{k} \geq R 2 * {\sum }_{j ∈ J} {a}_{ij} {x}_{j} , ∀ i ∈ 𝒟 \qquad ( 4 b )$$

By setting an upper bound (R1) and lower bound (R2), the constraint may ensure that most manhours come from full-time shifts, while still allowing for a number of fixed part-time shifts.

Fourth constraint, a maximum number is set for the total number of selected shifts.

$${\sum }_{j ∈ J} {u}_{j} \leq B 1 \qquad ( 5 a )$$

$${\sum }_{k ∈ 𝒦} {v}_{k} \leq B 2 \qquad ( 5 b )$$

Last constraint, the first optimization model 110 may include a set of validation constraints.

$${x}_{j} \leq {Mu}_{j} , ∀ j ∈ 𝒥 \qquad ( 6 a )$$

$${y}_{k} \leq {Mv}_{k} , ∀ k ∈ 𝒦 \qquad ( 6 b )$$

$${x}_{j} \geq {u}_{j} , ∀ j ∈ 𝒥 \qquad ( 7 a )$$

$${y}_{k} \geq {v}_{k} , ∀ k ∈ 𝒦 \qquad ( 7 b )$$

$${x}_{j} \leq {δ}_{j} , ∀ j ∈ 𝒥 \qquad ( 8 a )$$

$${y}_{k} \leq {δ}_{k} , ∀ k ∈ 𝒦 \qquad ( 8 b )$$

In some embodiments, Eq. 6a and 6b may guarantee that if the shifts are not chosen, their corresponding headcounts will be set to zero. Eq. 7a and 7b may ensure that when the shifts are selected, their corresponding headcounts will be positive. Furthermore, Eq. 8a and 8b may ensure that if there is no demand on a particular day, any shifts with positive man-hours on that same day will not be selected.

In some embodiments, the output uⱼ and vₖ represent a set of optimal full-time and fixed part-time shifts that are applicable for the entire planning horizon. In some embodiments, these outputs are utilized as inputs for the second optimization model 112.

In some embodiments, a set of parameters of the first optimization model 110 and a second set of parameters of the second optimization model 112, which is to be discussed below, may be the same. Alternatively, the set of parameters of the first optimization model 110 may be different to the second set of parameters of the second optimization model 112. As described above, the first set of parameters may include a number of hours worked on a day for full-time shift, a number of hours worked on a day for fixed part-time shift, a manhour demand on a day in a pseudo week, a daily tail factor, a weekly tail factor, a number of full-time shifts to be chosen, and/or a number of part-time shifts to be chosen.

### Second Optimization Model 112—Determine Headcounts and Variable Part-Time Shifts

In some embodiments, the second optimization model 112 includes multiple models that may cover the planning horizon (or a particular period of time) in a sequential manner. These models may be designed to plan for multiple weeks at a time (e.g., 5 weeks, 9 weeks, to name a few). In some embodiments, the second optimization model 112 may define a second set of parameters, second decision variables, and/or second constraints. For example, one or more or each model of the second optimization model 112 may include the following sets:

Set [symbol] , [symbol] , [symbol] is the same as in the first optimization model 110. [symbol] is the set of valid variable part-time shifts for ∀lϵ [symbol] . [symbol] is set of weeks for ∀wϵ [symbol] .

In some embodiments, the model parameters may include as follows:

uⱼ and vₖ are the outputs of first optimization model 110 and represent the selection results for full-time shift j and fixed part-time shift k respectively.

α, β, aᵢⱼ, bᵢₖ, B, R1 and R2, M are defined in the first optimization model 110 and remain the same in the second optimization model 112.

cᵢₗ represents the number of hours on day i for variable part time shift l.

r_{iw} denotes the manhour demand on day i for week w.

δₗ is the validation indicator same as δⱼ defined in the first optimization model 110.

R3 is the maximum manhour ratio between variable part-time shifts to the type of part-time shifts. In an illustrative non-limiting example, the types of part-time shifts may include man hour ratio of variable part time shifts to that of overall (fixed+variable) part time shifts.

V1, V2, V3 is the maximum FT, FPT and total headcount variation from week to week.

W is the number of planning weeks in the model.

In some embodiments, the decision variables are defined as follows:

sₗₖ is binary indicator on variable part-time shift selection on week w.

x_{jw} is the headcount to work on full-time shift j on week w.

y_{kw} is the headcount for fixed part-time shift k on week w.

z_{lw} is the headcount for variable part-time shift l on week w.

In some embodiments, the objective function is to minimize the total manhour used during W planning weeks.

$$min {\sum }_{w ∈ 𝒲} {\sum }_{i ∈ 𝒟} ( {\sum }_{j ∈ 𝒥} {a}_{ij} {x}_{jw} + {\sum }_{k ∈ 𝒦} {b}_{ik} {y}_{kw} + {\sum }_{l ∈ ℒ} {c}_{il} {z}_{lw} ) \qquad ( 9 )$$

The second optimization model 112 may consider the following constraints.

First, the daily manhour throughput must meet the daily demand with tail factor adjustment.

$${\sum }_{j ∈ 𝒥} {a}_{ij} {x}_{jw} + {\sum }_{k ∈ 𝒦} {b}_{ik} {y}_{kw} + {\sum }_{l ∈ ℒ} {c}_{il} {z}_{lw} \geq α {r}_{iw} , ∀ i ∈ 𝒟 , ∀ w ∈ 𝒲 \qquad ( 10 )$$

Eq. 10 shares similarities with Eq. 2 but includes additional variable part-time shifts.

Next, meeting the weekly demand with tail factor adjustment.

$${\sum }_{i ∈ 𝒟} {\sum }_{j ∈ 𝒥} {a}_{ij} {x}_{jw} + {\sum }_{i ∈ 𝒟} {\sum }_{k ∈ 𝒦} {b}_{ik} {y}_{kw} + {\sum }_{i ∈ 𝒟} {\sum }_{l ∈ ℒ} {c}_{il} {z}_{lw} \geq β {\sum }_{i ∈ 𝒟} {r}_{iw} , ∀ w ∈ 𝒲 \qquad ( 11 )$$

Next set of constraints may ensure the daily part-time/full-time manhour ratio is within a certain range.

In an illustrative non-limiting example, part time man hours may not be more than 20% of overall man-hours. In some embodiments, the period range of the part time man hours is part of the business rules described herein.

$$\begin{matrix}{\sum }_{k ∈ 𝒦} {b}_{ik} {y}_{kw} + {\sum }_{l ∈ ℒ} {c}_{il} {z}_{lw} \leq R 1 {\sum }_{j ∈ 𝒥} {a}_{ij} {x}_{jw} & ∀ i ∈ 𝒟 , ∀ w ∈ 𝒲\end{matrix} \qquad ( 12 a )$$

$$\begin{matrix}{\sum }_{k ∈ 𝒦} {b}_{ik} {y}_{kw} + {\sum }_{l ∈ ℒ} {c}_{il} {z}_{lw} \geq R 2 {\sum }_{j ∈ 𝒥} {a}_{ij} {x}_{jw} & ∀ i ∈ 𝒟 , ∀ w ∈ 𝒲\end{matrix} \qquad ( 12 b )$$

Then, it may limit the proportion of variable part-time man-hours in the part-time category to a maximum number.

$$\begin{matrix}{\sum }_{l ∈ ℒ} {c}_{il} {z}_{lw} \leq R 3 * {\sum }_{k ∈ 𝒦} {b}_{ik} {y}_{kw} & ∀ i ∈ 𝒟 , ∀ w ∈ 𝒲\end{matrix} \qquad ( 13 )$$

The number of headcounts for FT, FPT, and total headcounts assigned for week w.

$$FT ( w ) = {\sum }_{j ∈ 𝒥} {x}_{jw} \qquad ( 14 a )$$

$$FPT ( w ) = {\sum }_{j ∈ 𝒥} {x}_{jw} \qquad ( 14 b )$$

$$H ( w ) = {\sum }_{j ∈ 𝒥} {x}_{jw} + {\sum }_{k ∈ 𝒦} {y}_{kw} + {\sum }_{l ∈ ℒ} {z}_{lw}$$

Next constraint may set the maximum weekly number of total shifts selected.

$${\sum }_{j ∈ J} {u}_{j} + {\sum }_{k ∈ 𝒦} {v}_{k} + {\sum }_{l ∈ ℒ} {s}_{lw} \leq B , ∀ w ∈ 𝒲 \qquad ( 15 )$$

The next set of constraints may control the week-to-week headcount variation.

$$- V 1 \leq FT ( w ) - FT ( w + 1 ) \leq V 1 \qquad ( 16 a )$$

$$- V 2 \leq FPT ( w ) - FPT ( w + 1 ) \leq V 2 \qquad ( 16 b )$$

$$\begin{matrix}- V 3 \leq H ( w ) - H ( w + 1 ) \leq V 3 & ∀ w = 1 ...\end{matrix} W - 1 \qquad ( 16 c )$$

Finally, the following constraints for model validation:

$${z}_{lw} \leq {Ms}_{lw} , ∀ l ∈ ℒ , ∀ w ∈ 𝒲 \qquad ( 17 )$$

$${z}_{lw} \geq {s}_{lw} , ∀ l ∈ ℒ , ∀ w ∈ 𝒲 \qquad ( 18 )$$

$${s}_{lw} \leq {δ}_{lw} , ∀ l ∈ ℒ , ∀ w ∈ 𝒲 \qquad ( 19 )$$

In some embodiments, Eq. 17 guarantees if the variable part-time shifts are not chosen, their corresponding headcounts will be set to zero. In some embodiments, Eq. 18 ensures when the variable part-time shifts are selected, their corresponding headcounts will be positive. In some embodiments, Eq. 19 ensures if there is no demand on a particular day, any variable part-time shifts with positive man-hours on that same day will not be selected.

In an illustrative non-limiting example, the second optimization model 112 and the processes described herein may be repeated several times to cover the entire planning horizon. In some embodiments, the resulting labor planning output may be a combination of the outcomes from both first optimization model 110 and second optimization model 112.

One of the business requirements is to keep the full-time shifts and/or fixed part-time shifts constant for the entire planning horizon. For example, the entire planning horizon could range from 12 weeks to 52 weeks. As such, in some embodiments, the first optimization model 110 may identify the optimal shifts that remain the same for the planning horizon. In some embodiments, the second optimization model 112 may use those optimal shifts from the first optimization model 110 as inputs. In some embodiments, the entire planning horizon may be further broken down into multiple hiring windows to decide on the headcounts and introduce variable part-time shifts as described above. For example, the second optimization model 112 when executed may provide first headcounts for full-time shift and part-time shift. Alternatively or in addition to, the second optimization model 112 when executed may select optimal variable shift patterns. Alternatively or in addition to, the second optimization model 112 when executed may assign second headcounts to each optimal variable shift pattern.

In some embodiments, the first optimization model 110 may solely satisfy the business requirement to keep the full-time shifts and/or fixed part-time shifts constant for the entire planning horizon. In some embodiments, both the first optimization model 110 and the second optimization model 112 may be executed to avoid unnecessary long run time that may be experienced when executing solely the first optimization model 110. In such embodiments, executing both the first optimization model 110 and the second optimization model 112 may provide a better solution and faster run time.

In an illustrative non-limiting example, a control circuit 102 may receive a fulfillment center (FC) level demand forecast for a particular period (e.g., 6 weeks, 12 weeks, or any other number of weeks). In some embodiments, the control circuit 102 may receive and use along with the received FC level demand forecast associates productivity factors, such as units per hour (UPH) and/or holiday sickness vacation (HSV) percentage from a dataset (e.g., HR database) stored from a database 104. In some embodiments, the control circuit 102 may define one or more parameters input to the first optimization model 110 and/or the second optimization model 112. In some embodiments, the one or more parameters may include a FT shift pattern, a number of FT shifts, a number of FPT shifts, a number of VPT shifts, an intra-day tail factor, an intra-week tail factor, a FT %, a VPT %/PT %, and/or a FT/PT weekly variation.

FT shift pattern may include a facility's FT shifts and/or a generated flexible pattern of FT shifts. In some embodiments, flexible shifts may be provided by a general manager of a fulfilment center and/or generated by the first optimization model 110 from a larger pool of valid full-time shifts identified from the business rules. Number of FT shifts may include a maximum number of shifts that can be used for FT employees. Number of FPT shifts may include a maximum number of shifts that can be used for FPT employees. Number of VPT shifts may include a maximum number of shifts that can be used for VPT employees. Intra-day tail factor parameter may allow intra-day demand redistribution to a small percentage. For example, the intra-day tail factor parameter may correspond to a value of 1 to ensure meeting a demand of 100%. Intra-week tail factor parameter may allow intra-week demand redistribution to a small percentage. For example, the intra-week tail factor parameter may correspond to a value of 1 to ensure meeting a demand of 100%. FT % may include a daily minimum FT manhour proportion among all planning manhours. VPT %/PT % may include a daily maximum VPT manhour proportion among all planning PT manhours. FT/PT weekly variation may include a HC week-to-week variation.

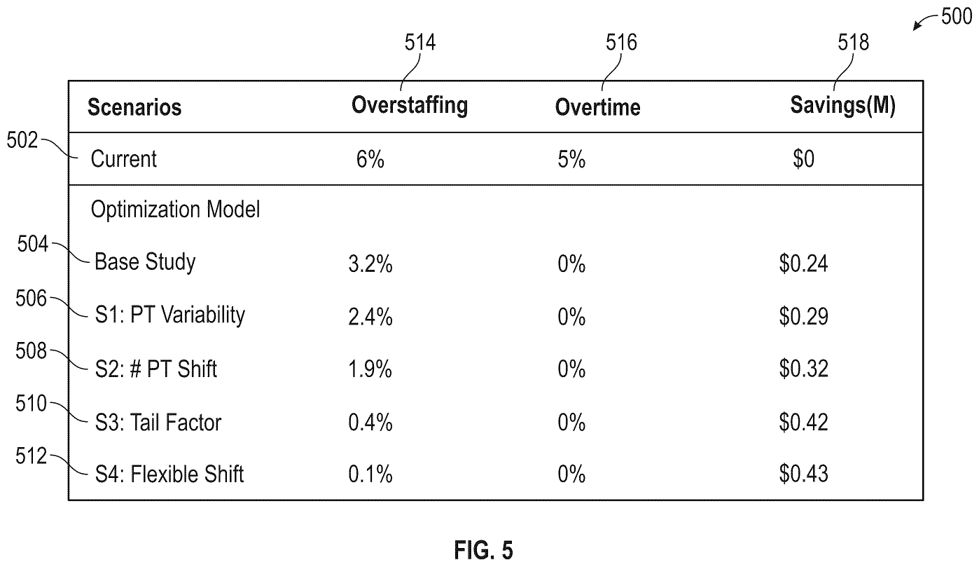

FIG. 5 illustrates exemplary scenarios 500 for optimizing labor resources at a facility in accordance with some embodiments. In some embodiments, a plurality of scenarios may be run to determine the optimal shift patterns for full-time employees, part-time employees, and/or variable part-time employees that minimizes labor costs while maintaining consistent shift patterns for a period of time.

In an illustrative non-limiting example, a plurality of metrics may be considered in evaluating each of the plurality of scenarios. In some embodiments, the plurality of metrics may include an overtime rate, an overstaffing rate, and/or a cost saving. For example, one common issue that may arise in labor planning is overtime, which occurs when employees work more than their regular hours. While overtime can be necessary in some cases, it may also lead to increased labor costs and reduced employee satisfaction. Moreover, if overtime is not managed properly, it can result in employee burnout and turnover, leading to productivity loss and additional costs for the organization. Thus, a lower overtime rate 516 may indicate better labor planning.

Another example, a problem may arise when more associates are scheduled than necessary to cover shifts, due to inadequate scheduling processes. In such instances, facility associates may be encouraged to take voluntary time off (VTO) without getting the hourly pay resulting in either decreased productivity and/or reduced associate satisfaction. Thus, a lower overstaffing rate 514 may indicate better labor planning.

Another example, the labor cost for the planning horizon including average hourly wage and the benefits is calculated by taking the difference between the optimization model (e.g., one of optimization scenarios 504, 506, 508, 510, 512 described herein) and the current labor planning tool used by a retailer (e.g., an unoptimized FC level demand forecast scenario 502) for cost saving 518.

In some embodiments, the unoptimized FC level demand forecast scenario 502 may be initially ran. The present disclosure described herein provides the ability to choose from multiple fixed and/or part time shifts as opposed to the conventional fixed set of 3 full time shifts and only fixed full-time labor, for example.

In some embodiments, a base optimization scenario 504 may be run. For example, the input parameters used for the base optimization scenario may include a default FT shift pattern, an FT/FPT weekly variation corresponding to zero variation for every 6 weeks, a number of FT shifts corresponding to a value of 4, a number of FPT shifts corresponding to a value of 4, a number of VPT shifts corresponding to a value of 8, an intra-day tail factor corresponding to a value of 1, an intra-week tail factor corresponding to a value of 1, FT % corresponding to a value of 60%, and VPT/PT % corresponding to a value of 80%.

In some embodiments, the default FT shift pattern may include current FT shifts that vary across different fulfilment centers (FC). For example, each FC may have 3 shifts per week, 2-day shifts, and a night shift. In an illustrative non-limiting example, the default FT shift pattern may include first day shift (S1) that may run from Monday to Thursday and is of 10.5 hours each day, second day shift (S2) that may run from Friday to Sunday and is of 12 hours each day, night shift may only operate from Monday to Thursday and is of 10 hours each day.

In some embodiments, a PT variability scenario 506 is run. For example, the input parameters used for the PT variability scenario 506 may include changing the VPT/PT % from 80% to 100% relative to the base optimization scenario 504 to increase the part-time variability and proportion.

In some embodiments, a number of PT shift scenario 508 is run. For example, the input parameters used for the number of PT shift scenario 508 may include increasing the number of FPT shifts from 4 to 8 relative to the base optimization scenario 504.

In some embodiments, a tail factor scenario 510 is run. For example, the input parameters used for the tail factor scenario 510 may include changing the daily tail factor to 95% and allowing the intra-day demand redistribution up to 5% relative to the base optimization scenario 504.

In some embodiments, a flexible shift scenario 512 is ran. For example, the input parameters used for the flexible shift scenario 512 may include assigning a different FT shift pattern than the default FT shift pattern. For example, the FT shift pattern may be assigned to correspond to 10 working hours per day and any combination of 4 working days per week.

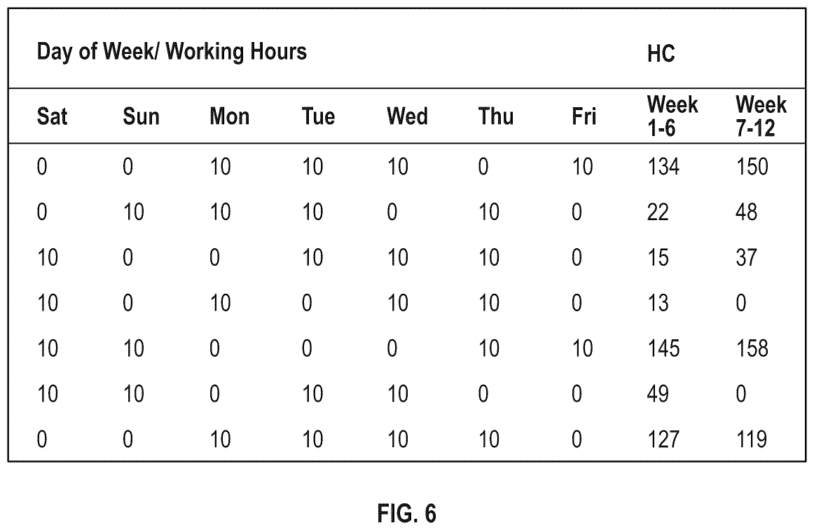

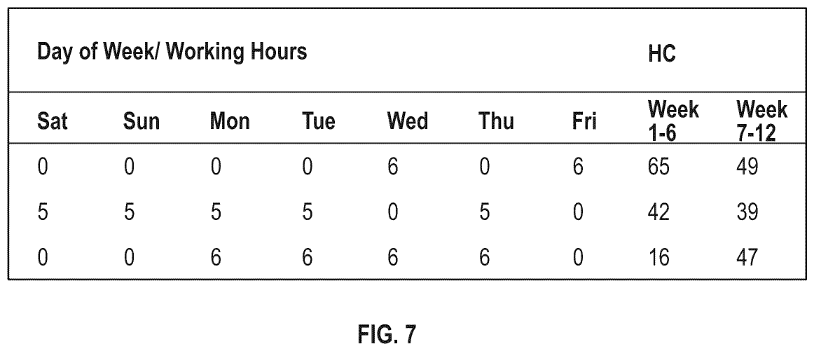

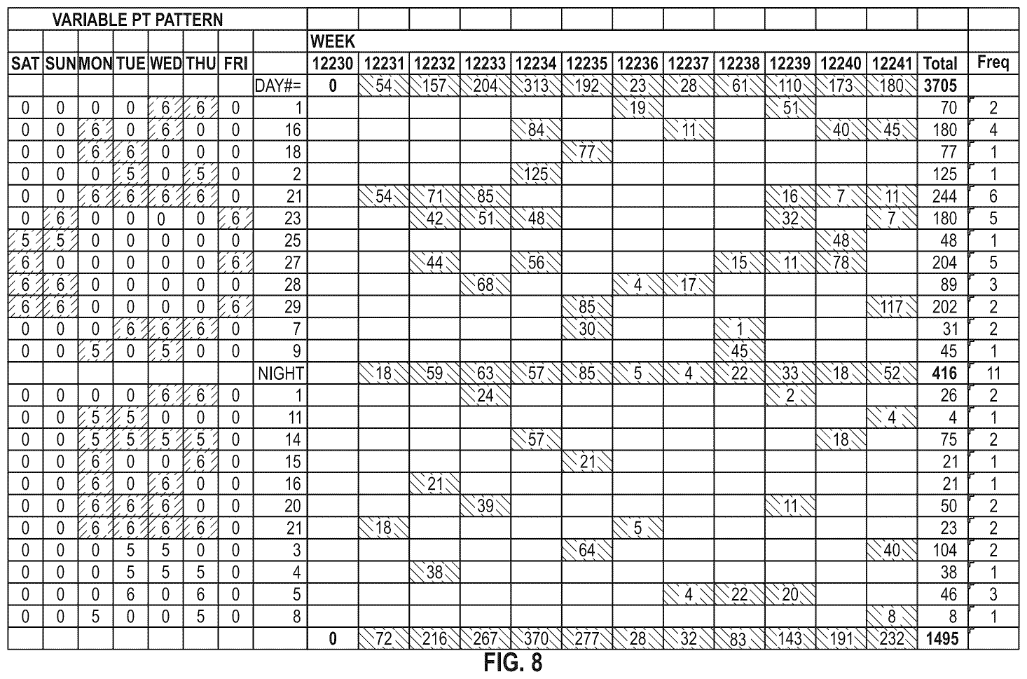

In an illustrative non-limiting example, FIG. 5 shows the resulting comparison between the current labor planning tool 502 and optimization run in difference scenarios 504, 506, 508, 510, 512. As shown in FIG. 5, the flexible shift scenario 512 provides the most cost savings relative to the other scenarios. FIGS. 6-8 represent the results of the first and second optimization models 110 and 112. In FIG. 6, a resulting selected FT pattern and HC planning for the flexible shift scenario 512 is shown. In particular, FIG. 6 shows the flexible full time (FT) shifts selected by one or more of the first optimization model 110 and the second optimization model 112. For example, the head counts against each FT shift may be displayed for periods of 6 weeks. In FIG. 7, a resulting selected FPT pattern and HC planning for the flexible shift scenario 512 is shown. In particular, FIG. 7 shows fixed part time (PT) shifts selected by one or more of the first optimization model 110 and the second optimization model 112. For example, the head counts against each PT shift may be displayed for periods of 6 weeks. In FIG. 8, a selection of VPT pattern and HC assignment resulting from the flexible shift scenario 512 is shown. In particular, FIG. 8 shows the variable shift selected by the model for week 30 to 41 along with the respective head counts.

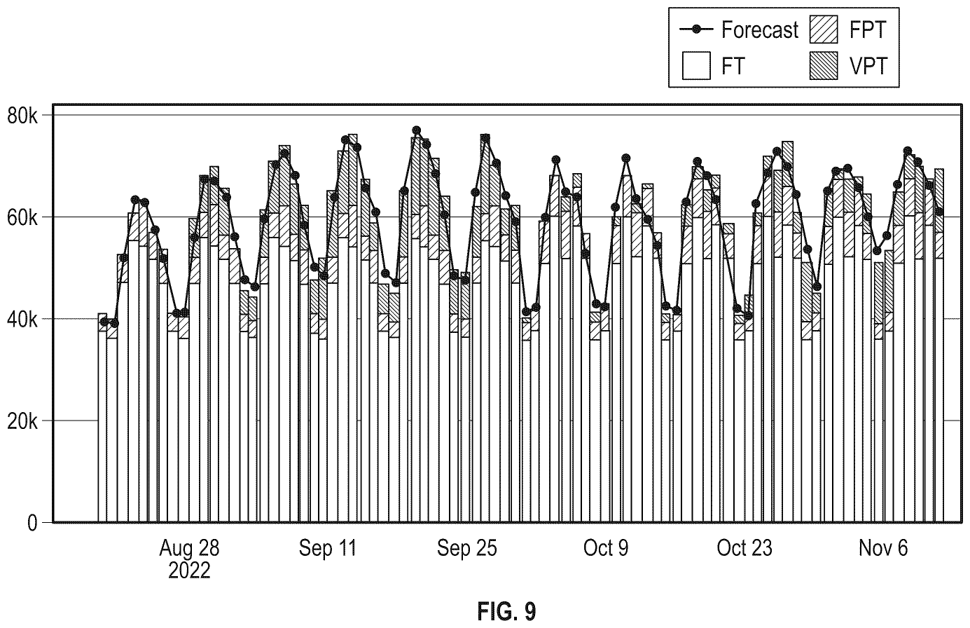

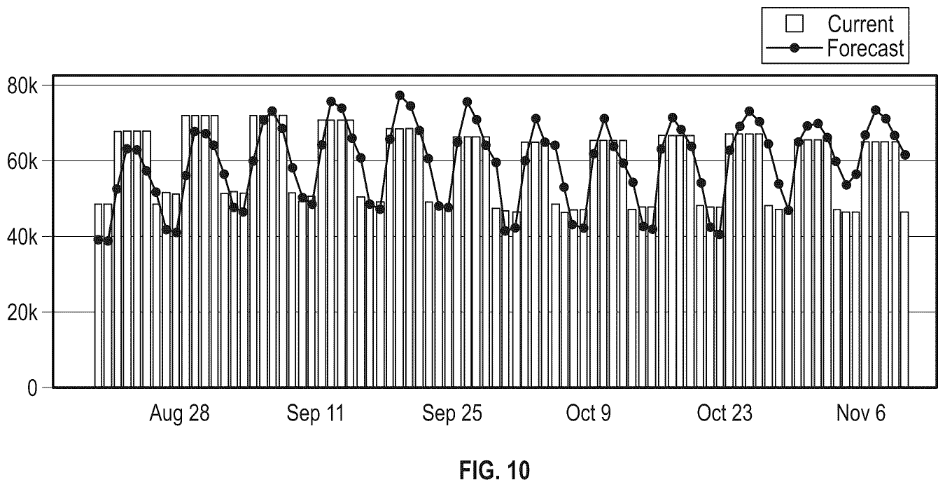

In some embodiments, FIGS. 9 and 10 illustrate the accuracy of the optimization model's 504, 506, 508, 510, 512 daily throughput coverage of the demand compared to the current labor planning tool (e.g., an unoptimized FC level demand forecast scenario 502). FIG. 9 illustrates the daily throughput comparison between optimization model and demand. FIG. 10 illustrates the daily throughput comparison between current labor planning tool and demand forecast. Thus, the use of the two-stage MILP model described herein provides a more accurate allocation of labor resources to the forecasted demand while maintaining a fixed shift pattern over a planning horizon.

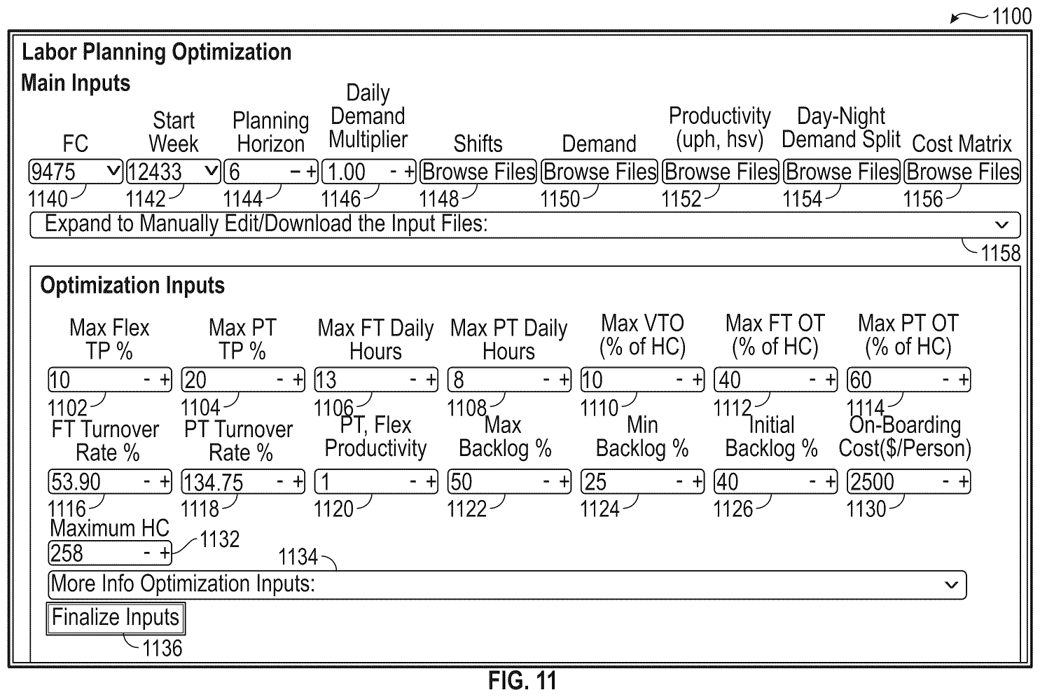

FIG. 11 illustrates a user interface (UI) 1100 where various inputs can be input by a user for use by system 100. As shown, inputs can include the various constraints and inputs discussed herein. Optimization section inputs include sections 1102, 1104 for maximum flex-time and part-time throughput percentage. Optimization section inputs include sections 1106, 1108 for maximum daily hours for each full-time and part-time employee. Optimization section inputs include section 1110 for max VTO and sections 1112, 1114 max full-time and part-time overtime. Optimization section inputs include sections 1116, 1118 for full-time and part-time turnover rates. Optimization section inputs include section 1120 for part-time and flex-time employee productivity. Optimization section inputs include sections 1122, 1124, 1126 for maximum, minimum, and initial backlog percentages. Optimization section inputs include sections 1130 for onboarding costs and 1132 for maximum headcount. Optimization section inputs include section 1134 which is a selection menu where the user can select from the various additional constraints and inputs discussed herein and add additional sections for entering the associated inputs. UI 1100 includes a button 1136 selectable for finalizing the inputs for processing by system 100. UI 1100 further includes a main inputs section where sections 1140-1156 can be utilized for entering various other input. Additionally, various sections, such as sections 1148-1156 shown, can be utilized for entering constraints, data, or input as a data file. Section 1158 can be utilized to manually edit any of the data files or input additional files. Accordingly, system 100, and specifically optimization models 110 and 112 can operate and perform the calculations, computations, methods, and processes discussed herein using the input entered via UI 1100 as constraints or controlling input.

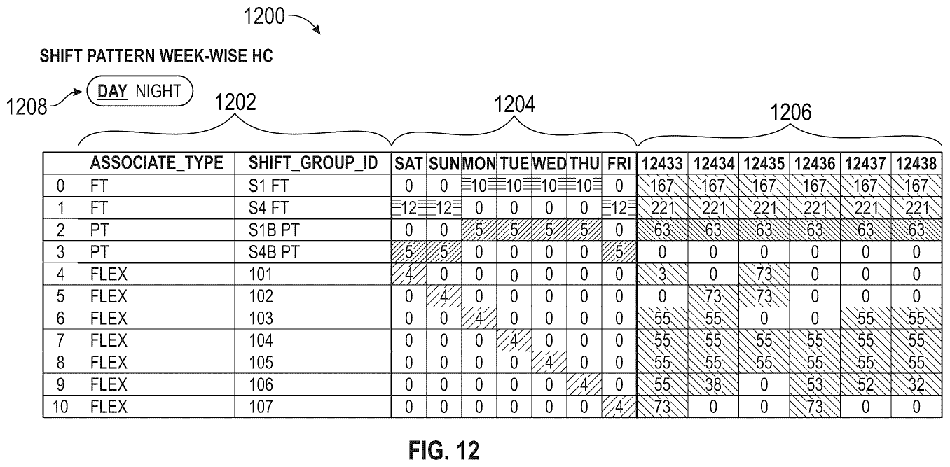

FIG. 12 is a shift schedule 1200, similar to the schedule discussed in FIG. 8 and, in some examples, is an output created by system 100. In some examples, a UI is updated to display schedule 1200 after inputs are entered via UI 1100. Schedule 1200 includes section 1202 which defines an employee or associate type (full-time, part-time, or flex-time) as well as shift groups within that associate type. Section 1204 defines, for a given week, the shift pattern taken by each employee type on each day. As shown, section 1204 shows the number of hours worked by each employee type on each day. Section 1206 shows the number of employees of each employee type needed per week, or the headcount. As shown in section 1204, full-time employees from a first full-time employee shift group are scheduled to work for 10 hours a day for Monday-Thursday, and full-time employees from a second full-time employee shift group are scheduled to work 12 hours a day on Friday-Sunday. As shown in section 1204, part-time employees from a first part-time employee shift group are scheduled to work for 5 hours a day for Monday-Thursday, and part-time employees from a second part-time employee shift group are scheduled to work 5 hours a day on Friday-Sunday. As shown, flex-time employees are scheduled to work for 4 hours for each day of the entire week, and each day employees are used from a different one of seven flex-time shift groups. In section 1206, the number of each employee type needed to work the schedule in section 1204 is shown for given weeks (each week corresponding to a week ID 12433-12438). As shown in section 1206, in this example, the headcount numbers for full-time and part-time employees remains constant over the span of weeks, while the number of flex time employees over the span of weeks is variable. Accordingly, in some examples, flex-time employees are used to account for variable demands and can be added or removed from the schedule as necessary according to the demand. In some examples, schedules are made for both day-shift and night-shift employees, and a user can toggle back and forth between the two schedules using the selectable “day” and “night” options in section 1208.

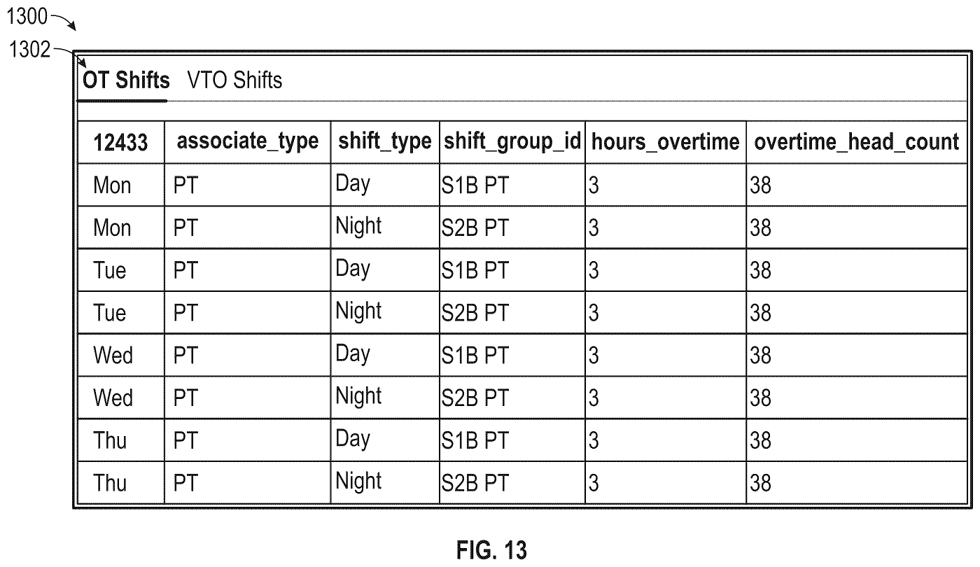

FIG. 13 is an overtime schedule 1300 and, in some examples, is an output created by system 100. In some examples, a UI is updated to display schedule 1300 after inputs are entered via UI 1100. As shown, schedule 1300 provides, for each day of a given week, overtime information for the day shift and the night shift. As shown, schedule 1300 provides that 38 part-time employees are needed to work three hours of overtime for both the day and night shift for Monday-Thursday of a given week. In some examples, schedules are made for both overtime and voluntary time off (VTO), and a user can toggle back and forth between the two schedules using the selectable “OT Shifts” and “VTO Shifts” options in section 1302.

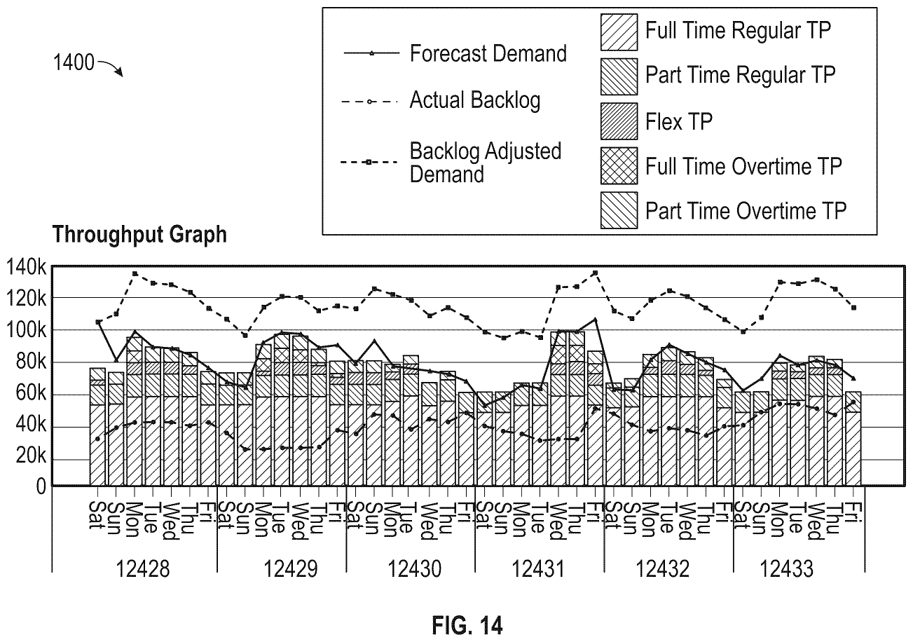

FIG. 14 illustrates a throughput graph 1400, similar to the graphs discussed in FIGS. 9 and 10 and, in some examples, is an output created by system 100. In some examples, a UI is updated to display graph 1400 after inputs are entered via UI 1100. As shown, graph 1400 includes a forecasted demand, and generates an optimized schedule for meeting the forecasted demand using full-time, part-time, and flex-time throughput; and full-time and part-time overtime throughput. Additionally, graph 1400 illustrates the actual backlog as well as the backlog adjusted demand, which is the actual backlog applied to the forecasted demand.

One of the benefits provided by the present disclosure is that the planning horizon is broken down into multiple layers and provides optimal shift patterns and headcounts for full-time and/or part-time shifts while meeting daily/weekly demand and complying with HR policies. In some embodiments, the shifts may be selected based on the HR rules, such as the presence of minimum holiday per week, to name a few. Moreover, the present disclosure allows for analysis of various scenarios (what-if) for various demand scenarios showing an annual labor cost savings, reduction of overstaffing rate, and elimination of overtime rate. As such, the two-stage MILP model-based approach provides a more flexible and efficient labor planning process for a facility.

In some embodiments, one or more of the first optimization model 110 or the second optimization model 112 may be executed by the control circuit 102 using the input parameters set by the business users. In an illustrative non-limiting example, customers may fine tune the input parameters as per their business needs to generate better results. In some embodiments, as part of continuous monitoring and improvement, additional features, such as backlog demand handling, may be incorporated with or used as input to one or more of the first optimization model 110 or the second optimization model 112 to enhance accuracy of both models. In some embodiments, the two-stage model for task level labor planning may be enhanced based on acceptance of daily level parameters and run for real time labor scheduling.

In some embodiments, one or more of the first optimization model 110 or the second optimization model 112 may be scheduled to run using workflow management tools. In an illustrative non-limiting example, workflow management tools may include Apache Airflow. In some embodiments, one or more of the first optimization model 110 or the second optimization model 112 may be triggered to run by inputting one or more predefined input model parameters.

In some embodiments, the output of the first optimization model 110 and the second optimization model 112 may be used by an integrated planning tool to plan the hiring at a facility and/or input into a scheduling system used at the facility.

In some embodiments, the output of the first optimization model 110 and the second optimization model 112 may be written or stored into one or more databases 104. For example, remote or other control circuits may access the output from the one or more databases 104 or cause the display of the output onto display devices reviewable by multiple users simultaneously.

In some embodiments, the control circuit 102 may execute multiple instances of the first optimization model 110 and the second optimization model 112. Each instance may be associated with a particular facility, and has a demand profile and model parameters particular to the facility being input to one or more of the first optimization model 110 or the second optimization model 112 to generate the shifts and head count for that corresponding facility.

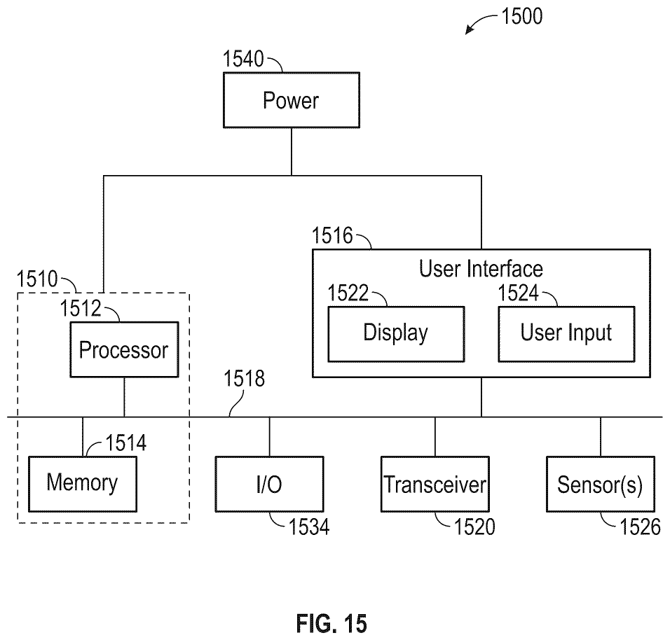

Further, the circuits, circuitry, systems, devices, processes, methods, techniques, functionality, services, servers, sources and the like described herein may be utilized, implemented and/or run on many different types of devices and/or systems. FIG. 15 illustrates an exemplary system 1500 that may be used for implementing any of the components, circuits, circuitry, systems, functionality, apparatuses, processes, or devices of the system 100 of FIG. 1, the method 200 of FIG. 2, the system 300 of FIG. 3, the process 400 of FIG. 4, and/or other above or below mentioned systems or devices, or parts of such circuits, circuitry, functionality, systems, apparatuses, processes, or devices. For example, the system 1500 may be used to implement some or all of the system for optimizing labor resources at a facility, the database/s 104, the control circuit 102, the electronic device 106, the memory 108, the communication network 114, and/or other such components, circuitry, functionality and/or devices. However, the use of the system 1500 or any portion thereof is certainly not required.

By way of example, the system 1500 may comprise a processor module (or a control circuit) 1512, memory 1514, and one or more communication links, paths, buses or the like 1518. Some embodiments may include one or more user interfaces 1516, and/or one or more internal and/or external power sources or supplies 1140. The control circuit 1512 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1512 can be part of control circuitry and/or a control system 1510, which may be implemented through one or more processors with access to one or more memory 1514 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1500 may be used to implement one or more of the above or below, or parts of, components, circuits, systems, processes and the like. For example, the system 1500 may implement the system 100 for optimizing labor resources at a facility with the control circuit 102 being the control circuit 1512.

The user interface 1516 can allow a user to interact with the system 1500 and receive information through the system. In some instances, the user interface 1516 includes a display 1522 and/or one or more user inputs 1524, such as buttons, touch screen, track ball, keyboard, mouse, etc., which can be part of or wired or wirelessly coupled with the system 1500. Typically, the system 1500 further includes one or more communication interfaces, ports, transceivers 1520 and the like allowing the system 1500 to communicate over a communication bus, a distributed computer and/or communication network (e.g., a local area network (LAN), the Internet, wide area network (WAN), etc.), communication link 1518, other networks or communication channels with other devices and/or other such communications or combination of two or more of such communication methods. Further the transceiver 1520 can be configured for wired, wireless, optical, fiber optical cable, satellite, or other such communication configurations or combinations of two or more of such communications. Some embodiments include one or more input/output (I/O) interface 1534 that allow one or more devices to couple with the system 1500. The I/O interface can be substantially any relevant port or combinations of ports, such as but not limited to USB, Ethernet, or other such ports. The I/O interface 1534 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1526 to provide information to the system and/or sensor information that is communicated to another component, such as the central control system, a portable retail container, a vehicle associated with the portable retail container, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1500 comprises an example of a control and/or processor-based system with the control circuit 1512. Again, the control circuit 1512 can be implemented through one or more processors, controllers, central processing units, logic, software and the like. Further, in some implementations the control circuit 1512 may provide multiprocessor functionality.

The memory 1514, which can be accessed by the control circuit 1512, typically includes one or more processor readable and/or computer readable media accessed by at least the control circuit 1512, and can include volatile and/or nonvolatile media, such as RAM, ROM, EEPROM, flash memory and/or other memory technology. Further, the memory 1514 is shown as internal to the control system 1510; however, the memory 1514 can be internal, external or a combination of internal and external memory. Similarly, some or all of the memory 1514 can be internal, external or a combination of internal and external memory of the control circuit 1512. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 1514 can store code, software, executables, scripts, data, content, lists, programming, programs, log or history data, user information, customer information, product information, and the like. While FIG. 15 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for optimizing labor resources at a facility, the system comprising:
a memory configured to store a first optimization model and a second optimization model, wherein the first optimization model when executed determines optimal shift patterns for full-time employee schedules and fixed part-time employee schedules over a period of time, and wherein the second optimization model when executed determines headcounts and variable part-time shifts;
one or more databases configure to store resource data used in determining forecasted demand;
a control circuit communicatively coupled to the memory and the one or more databases, the control circuit configured to:
calculate an average forecasted demand for each day of a week based on the resource data;
generate a one-week demand estimate based on the calculated average forecasted demand;
execute the first optimization model using the one-week demand estimate to output the optimal shift patterns for the full-time employee schedules and the fixed part-time employee schedules; and
execute the second optimization model using the optimal shift patterns for the full-time employee schedules and the fixed part-time employee schedules to output the headcounts and the variable part-time shifts; and
an electronic device configured to execute an application stored in a local memory of the electronic device, the application when executed causes the control circuit to output one or more staffing recommendation levels displayable on the electronic device.

2. The system of claim 1, wherein the facility comprises a retail store, a fulfillment center, and a distribution center.

3. The system of claim 1, wherein the first optimization model comprises a set of valid full-time shifts, a set of valid fixed part-time shifts, and a set of day within a week.

4. The system of claim 3, wherein the second optimization model comprises the set of valid full-time shifts, the set of valid fixed part-time shifts, and the set of day within a week.

5. The system of claim 1, wherein the first optimization model defines a first set of parameters, first decision variables, and first constraints, and wherein the second optimization model defines a second set of parameters, second decision variables, and second constraints.

6. The system of claim 5, wherein the first set of parameters and the second set of parameters are the same.

7. The system of claim 5, wherein the first set of parameters comprise a number of hours worked on a day for full-time shift, a number of hours worked on a day for fixed part-time shift, a manhour demand on a day in a pseudo week, a daily tail factor, a weekly tail factor, a number of full-time shifts to be chosen, and a number of part-time shifts to be chosen.

8. The system of claim 1, wherein the second optimization model comprises a plurality of models covering the period of time in a sequential manner.

9. The system of claim 1, wherein the second optimization model when executed is configured to:
provide first headcounts for full-time shift and part-time shift;
select optimal variable shift patterns; and
assign second headcounts to each optimal variable shift pattern.

10. The system of claim 1, wherein the first optimization model and the second optimization model are Mixed Integer Linear Programming (MILP) model based algorithms.

11. A method for optimizing labor resources at a facility, the method comprising:
calculating, by a control circuit communicatively coupled to a memory and one or more databases, an average forecasted demand for each day of a week based on resource data, wherein the resource data is stored in the one or more databases and used in determining forecasted demand, and wherein a first optimization model and a second optimization model are stored in the memory;
generating, by the control circuit, a one-week demand estimate based on the calculated average forecasted demand;
executing, by the control circuit, the first optimization model using the one-week demand estimate to output optimal shift patterns for full-time employee schedules and fixed part-time employee schedules over a period of time;
executing, by the control circuit, the second optimization model using the optimal shift patterns for the full-time employee schedules and the fixed part-time employee schedules to output headcounts and variable part-time shifts; and
executing an application stored in a local memory of an electronic device, the application when executed causes the control circuit to output one or more staffing recommendation levels displayable on the electronic device.

12. The method of claim 11, wherein the facility comprises a retail store, a fulfillment center, and a distribution center.

13. The method of claim 11, wherein the first optimization model comprises a set of valid full-time shifts, a set of valid fixed part-time shifts, and a set of day within a week.

14. The method of claim 13, wherein the second optimization model comprises the set of valid full-time shifts, the set of valid fixed part-time shifts, and the set of day within the week.

15. The method of claim 11, wherein the first optimization model defines a first set of parameters, first decision variables, and first constraints, and wherein the second optimization model defines a second set of parameters, second decision variables, and second constraints.

16. The method of claim 15, wherein the first set of parameters and the second set of parameters are the same.

17. The method of claim 15, wherein the first set of parameters comprise a number of hours worked on a day for full-time shift, a number of hours worked on a day for fixed part-time shift, a manhour demand on a day in a pseudo week, a daily tail factor, a weekly tail factor, a number of full-time shifts to be chosen, and a number of part-time shifts to be chosen.

18. The method of claim 11, wherein the second optimization model comprises a plurality of models covering the period of time in a sequential manner.

19. The method of claim 11, further comprising:
providing, by the second optimization model when executed by the control circuit, first headcounts for full-time shift and part-time shift;
selecting, by the second optimization model when executed by the control circuit, optimal variable shift patterns; and
assigning, by the second optimization model when executed by the control circuit, second headcounts to each optimal variable shift pattern.

20. The method of claim 11, wherein the first optimization model and the second optimization model are Mixed Integer Linear Programming (MILP) model based algorithms.
